(19) United States
(12) Patent Application Publication
(10) Pub. No.: US 2009/0128851 A1
(43) Pub. Date: May 21, 2009

(54) IMAGE FORMING APPARATUS, DATA STORING METHOD THEREOF, AND COMPUTER READABLE RECORDING MEDIUM HAVING PROGRAM EXECUTING THE DATA STORING METHOD

(75) Inventor: Seong-kyoo PARK, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/271,079

(22) Filed: Nov. 14, 2008

(30) Foreign Application Priority Data
Nov. 19, 2007 (KR) 2007-118087

(51) Int. Cl. G06F 3/12; G06K 15/00

(52) U.S. Cl. 358/1.15; 358/1.16

(57) ABSTRACT

A data storing method of an image forming apparatus which is capable of being connected to a portable storing apparatus includes selecting a data which is to be stored in the portable storing apparatus, selecting a backup target file among a stored file in the portable storing apparatus and encrypting the backup target file if a storing space of the portable storing apparatus in which the selected data is to be stored is insufficient, deleting the backup target file and backing up the encrypted backup target file, and storing the selected data in the portable storing apparatus.

### CROSS-REFERENCE TO RELATED APPLICATIONS

This application claims priority under 35 U.S.C. §119(a) from Korean Patent Application No. 10-2007-0118087, filed on Nov. 19, 2007 in the Korean Intellectual Property Office, the disclosure of which is incorporated herein by reference in its entirety.

### BACKGROUND OF THE INVENTION

1. Field of the Invention

The present general inventive concept relates to an image forming apparatus, a data storing method thereof and a computer readable recording medium having a program executing the data storing method, and more particularly, to an image forming apparatus, a data storing method thereof and a computer readable recording medium having a program to execute the data storing method to conveniently store data in a portable storing apparatus.

2. Description of the Related Art

An image forming apparatus directly scans an image from a document as a scanner or an electric copier does, or indirectly generates image data by receiving the image data through a telephone network or receiving the image data from a host computer as a facsimile or a printer does. Also, the generated image data may be copied on a printing medium, or stored in a storing medium as necessary.

Also, an image forming apparatus which has been developed and released recently is capable of directly storing the generated image data in a portable storing apparatus such as a universal serial bus (USB) memory without a support of an external host apparatus. For this, the image forming apparatus includes a storing medium connecting unit (not illustrated) to which the portable storing apparatus is connected, and a control unit for driving the portable storing apparatus, for example, a USB host.

However, if the portable storing apparatus does not have a storing space sufficient to store the generated image data, the image data cannot be stored in the portable storing apparatus. Accordingly, to obtain the storing space, a user has to manually delete a file from the portable storing apparatus, or to perform a separate operation, causing a user inconvenience.

### SUMMARY OF THE INVENTION

The present general inventive concept provides an image forming apparatus, a data storing method thereof and a computer readable recording medium having a program executing the data storing method improving a user convenience.

The present general inventive concept also provides an image forming apparatus, a data storing method thereof and a computer readable recording medium having a program to execute the data storing method of backing up a file deleted from a portable storing apparatus to obtain a storing space of an image data.

The present general inventive concept also provides an image forming apparatus, a data storing method thereof and a computer readable recording medium having a program to execute the data storing method to prevent an unauthorized user from having access to a backup file.

Additional aspects of the present general inventive concept will be set forth in part in the description which follows and, in part, will be obvious from the description, or may be learned by practice of the present general inventive concept.

The foregoing and/or other aspects of the present general inventive concept can be achieved by providing a data storing method of an image forming apparatus which is capable of being connected to a portable storing apparatus, the data storing method comprising selecting data which is to be stored in the portable storing apparatus; selecting a backup target file among one or more stored files in the portable storing apparatus, and encrypting the backup target file if a storing space of the portable storing apparatus in which the selected data is to be stored is insufficient; deleting the backup target file, and backing up the encrypted backup target file, and storing the selected data in the portable storing apparatus.

The data storing method of the image forming apparatus may further comprise displaying the stored file to select the backup target file.

The encrypting may comprise determining at least one of an encrypting function and a file hiding function to the backup target file.

The backing up may comprise storing the backup target file in a storing unit of the image forming apparatus or a storing unit of a host apparatus.

The backing up may comprise allowing a user to select at least one of the encrypting function and the file hiding function.

The data storing method of the image forming apparatus may further comprise displaying a backup result of the backup target file.

The foregoing and/or other aspects of the present general inventive concept can also be achieved by providing an image forming apparatus which is capable of being connected with a portable storing apparatus, the image forming apparatus comprising a data output unit which outputs image data, and a control unit which encrypts a backup target file among one or more stored files which are stored in the portable storing apparatus, backs up the encrypted backup target file and deletes the backup target file in the portable storing apparatus, and then stores the image data in the portable storing apparatus if there is no storing space in the portable storing apparatus.

The control unit may determine at least one of an encrypting function and a file hiding function to the backup target file.

The image forming apparatus may further comprise a display panel, wherein the control unit displays in the display panel so that a user can select at least one of the encrypting function and the file hiding function.

The image forming apparatus may further comprise a display panel, wherein the control unit displays the stored file in the display panel so that a user can select the backup target file.

The image forming apparatus may further comprise a display panel, wherein the control unit displays a backup result of the encrypted backup target file in the display panel.

The foregoing and/or other aspects of the present invention can also be achieved by providing a computer readable recording medium, comprising a computer program which is provided to an image forming apparatus to execute a data storing method of the image forming apparatus, the method including selecting data which is to be stored in the portable storing apparatus; selecting a backup target file among one or more stored files in the portable storing apparatus, and encrypting the backup target file if a storing space of the portable storing apparatus in which the selected data is to be stored is insufficient; deleting the backup target file, and backing up the encrypted backup target file, and storing the selected data in the portable storing apparatus.

The foregoing and/or other aspects of the present invention can also be achieved by providing an image forming apparatus connectable with a portable storing apparatus, the image forming apparatus including a connecting port connectable to an external portable storing apparatus, and a control unit to communicate with the external portable storing apparatus through the connecting port, to delete at least one of one or more files stored in the external portable apparatus and to increase from a first storing space to a second storing space of the external portable apparatus according to the deletion of the at least one file.

A maximum storing space of the external portable storing apparatus may include at least one of a first sum of the first storing space and the deleted at least one file and a second sum of the second storing space and non-deleted files.

the first storing space may include a remaining storing space of the external portable storing apparatus, and the second storing space may include the remaining storing space and a space corresponding to the deleted at least one file.

The control unit may create an encryption file to correspond to the at least one of the files to be deleted, and may store the encryption file and information on the encryption file in at least one of a storage unit and the external portable storing apparatus.

The control unit may select the at least one of the files to be deleted when the control unit determines that the first storing space is smaller than a reference storing space.

The files may have priority, and the control unit may select the at least one of the files to be deleted according the priority of the files.

The control unit may store data in the external portable storing apparatus when there is an available storing space to store the data according to the deletion of the at least one file.

The foregoing and/or other aspects of the present invention can also be achieved by providing an image forming apparatus connectable with a portable storing apparatus, the image forming apparatus including a connecting port connectable to an external portable storing apparatus, a data output unit to outputs image data to the external portable storing apparatus through the connecting port, and a control unit to communicate with the external portable storing apparatus, to encrypts a backup target file among at least one of files stored in the external portable storing apparatus, to back up the encrypted backup target file, to delete the at lease on of the files corresponding to the backup target file from the portable storing apparatus to increase from a first storing space to a second storing space of the external portable apparatus according to the deletion of the at least one file, and to store the image data in the portable storing apparatus if there is no available storing space to store the image data in the portable storing apparatus.

### BRIEF DESCRIPTION OF THE DRAWINGS

These and/or other aspects of the present general inventive concept will become apparent and more readily appreciated from the following description of the exemplary embodiments, taken in conjunction with the accompanying drawings, in which:

FIG. 1 is a block diagram illustrating an image forming apparatus according to an exemplary embodiment of the present general inventive concept;

FIG. 2 is a flowchart illustrating a data storing method of an image forming apparatus according to an exemplary embodiment of the present general inventive concept;

FIGS. 3A and 3B are flowcharts illustrating a data storing method of an image forming apparatus according to an exemplary embodiment of the present general inventive concept;

FIG. 4 is a flowchart illustrating a data storing method of an image forming apparatus according to an exemplary embodiment of the present general inventive concept; and

FIGS. 5A and 5B are flowcharts illustrating a data storing method of an image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present invention by referring to the figures.

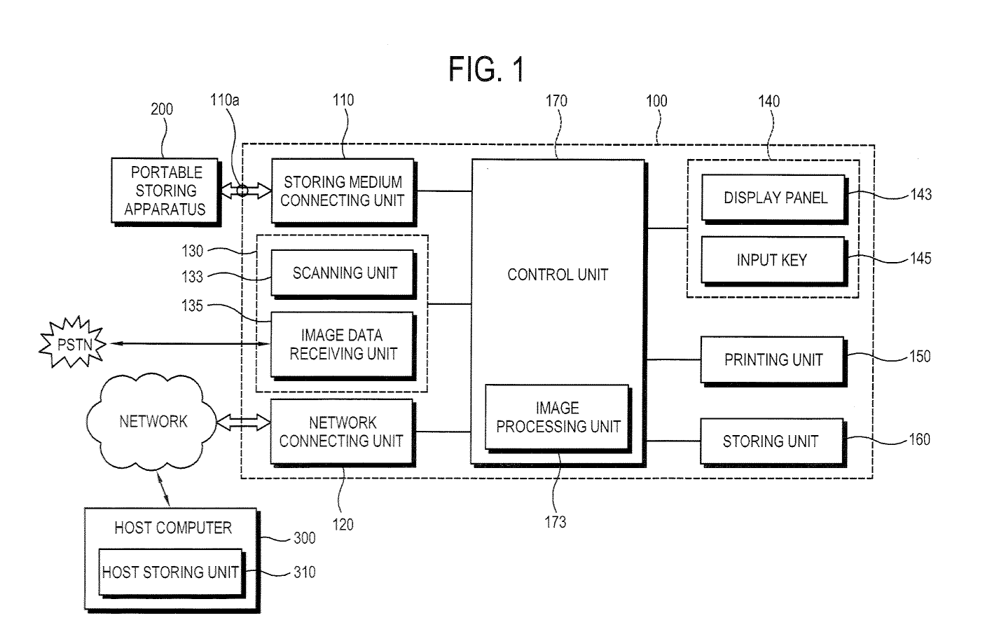

As illustrated in FIG. 1, an image forming apparatus 100 according to an exemplary embodiment of the present general inventive concept includes a storing medium connecting unit 110, a data output unit 130 and a control unit 170.

The storing medium connecting unit 110 includes a connecting port 110a to which a portable storing apparatus 200 such as a flash memory, a universal serial bus (USB) memory of a USB type, a portable hard disk or a personal digital assistant (PDA), and a connecting unit controller (not illustrated) to control the portable storing apparatus 200 through the connecting port 110a. The connecting unit controller may be provided to the control unit 170 instead of the storing medium connecting unit 110 as necessary. The connecting port 110a may be a USB port, and the connecting unit controller may be a USB host. Alternatively, conventional connecting types may be employed instead of the USB type.

The data output unit 130 receives image data from an external apparatus, or includes a scanning unit 133 to scan a document to output a scanned image data. The outputted image data may be printed by means of a printing unit 150, or may be stored in the portable storing apparatus 200.

Here, the scanning unit 133 may include at least one of a charge coupled device (CCD) sensor and a contact image sensor (CIS). Image information of a document scanned by means of the scanning unit 133 is converted into image data digitized by means of an image processing unit 173 of the control unit 170. This image data converting method may employ a conventional method.

The data output unit 130 may further include an image data receiving unit 135 to receive image data through from an external apparatus, for example, a public telephone network such as a public switched telephone network (PSTN), or an internet network of a wired or wireless connection.

Here, the image data receiving unit 135 may include at least one of a telephone modem and a network interface card.

As necessary, the image data receiving unit 135 may include one of a parallel port, a serial port and a USB port. Each port is connected to a separate host apparatus (not illustrated) different from a host apparatus 300 of FIG. 1 to receive printing data or image data from the host apparatus. Here, the printing data is image data which is made by an application of the host apparatus 300, and converted by means of a printer driver, etc., and is data which the image forming apparatus 100 is capable of understanding or using the same to print an image on a print medium. The printing data may include a printer controlling language such as a printer control language (PCL) or a postscript. The image data may be data representing a document. The image data may be one or more files each having image data.

The data output unit 130 may output the received printing data or image data. Here, the data output from the data output unit 130 is just an example, and the type of the data may vary.

The control unit 170 may temporarily store the image data generated from the data output unit 130 in a memory inside the control unit 170, or a storing unit 160.

Here, the control unit 170 may be provided as an embedded chip or a system on chip (SOC) embedded with an operating system (OS) to drive a file system to access to the file system stored in the portable storing apparatus 200.

Also, the control unit 170 determines whether there is a storing space in the portable storing apparatus 200 connected through the storing medium connecting unit 110 or not, and deletes a part or all of a stored file stored in the portable storing apparatus 200 if there is no storing space. Accordingly, a storing space capable of storing the temporarily stored image data is provided to the portable storing apparatus 200. Here, the control unit 170 may forcedly delete the stored file without allowing a user to select a deletion target file among the stored file.

Here, the ‘delete’ includes formatting newly setting a file system such as a file allocation table 32 (FAT32) and an NT file system (NTFS) in a case of the portable storing apparatus 200 such as a flash memory and a hard disk as well as deleting a separate file.

Also, the control unit 170 stores the image data in the obtained storing space corresponding to the deleted space and/or a remaining storing space of the portable storing apparatus 200. The image forming apparatus 100 according to the present exemplary embodiment may further include an operation panel 140.

The operation panel 140 may include a display panel 143 to display information to a user, and an input key 145 to receive an input from the user. Here, the display panel 143 may be provided as a liquid crystal display (LCD), or a plasma display panel (PDP).

The control unit 170 may receive from the user through the input key 145 an order or priority that the data output from the data output unit 130 is to be stored in the portable storing apparatus 200. Here, if there is no order (for example, an order that the image data is to be printed) or a priority from the user, the image data is determined to be stored in the portable storing apparatus 200 as a default option. The operation panel 140 may employ other various known configurations, and may be omitted as necessary.

If there is the order or priority that the image data generated from the data output unit 130 is stored in the portable storing apparatus 200, the control unit 170 may display information about one or more stored files through the display panel 143 before deleting a part or all of the stored files stored in the portable storing apparatus 200. Accordingly, since the user is capable of selecting a file which is desirable to be deleted through the display panel 143, a necessary file can be prevented from being deleted. The image forming apparatus 100 according to the present exemplary embodiment may further include the storing unit 160.

The storing unit 160 supplies a backup storing space in which the deletion target file among the files stored in the portable storing apparatus 200 for obtaining the storing space of the image data to be stored in the portable storing apparatus 200 is backed up.

The storing unit 160 may be provided as at least one of a volatile memory such as a dynamic random access memory (DRAM), a nonvolatile memory such as a flash memory, a hard disk drive or a solid state device (SSD). The storing unit 160 may be provided as other known configurations which are capable of storing a data. The storing unit 160 is preferably but not necessarily provided as the nonvolatile memory or the hard disk drive so that the backed up deletion target file can remain although power of the image forming apparatus 100 is turned off.

As necessary, if a host storing unit 310 of the host computer 300 provides the backup storing space, the storing unit 160 may be unnecessary.

The control unit 170 may back up all deletion target file in the storing unit 160 before deleting a part or all of the stored files stored in the portable storing apparatus 200. Accordingly, since the deleted file is backed up although the file stored in the portable storing apparatus 200 is forcedly deleted by means of the control unit 170, or is deleted by means of selection of the user, the user can be provided with a chance to reuse the deletion target file. As necessary, the control unit 170 may display in the display panel 143 so that the user can select the file which is wanted to be backed up among the deletion target file in a deletion file selecting mode.

Also, as necessary, the control unit 170 may display in the display panel 143 so that the user can select a backup target file which is wanted to be backed up among the deletion target file. That is, all deletion target file is not backed up, but only a part of the file which is selected by the user may be backed up.

As necessary, the control unit 170 may encrypt and backup the backup target file of the portable storing apparatus 200. Here, the encrypting includes providing a code to the deletion target file, and providing a file hiding function to the deletion target file.

Here, the file hiding function may make the backup target file invisible in a window explorer, etc. The control unit 170 may store the deletion target file which receives the security processing in at least one of the storing unit 160 and the host storing unit 310.

For this, the control unit 170 may control the display panel 143 to display an appropriate UI (User Interface not illustrated) so that the user can select one of the encryption setting function and the file hiding function for the deletion target file from the displayed UI. Alternatively, one or all of the above functions may be determined to be a default option so that an input from the user can be unnecessary.

Also, if the user selects the encryption setting function, the control unit 170 may receive an encryption from the input key 145 of the operation panel 140. The encryption may be a predetermined value as necessary.

For example, if a specific user group uses a specific encryption, the specific encryption is predetermined, and a source of data corresponds to the specific user group, the specific encryption may be automatically provided. The encryption inputted through the input key 145 is provided to the deletion target file, and stored in at least one of the portable storing apparatus 200 or the storing unit 160 of the image forming apparatus. For example, the encryption is provided to the deletion target file to be converted into a portable document format (PDF) (secure PDF) file provided with the encryption, and the PDF file provided with the encryption is stored to perform a security processing backup. As necessary, the user may be allowed to select the file to which the encryption is determined among the deletion target file.

More in detail about the encryption setting process, the control unit 170 displays file information (file name, a file data size, etc.) stored in the portable storing apparatus 200 in the display panel 143, and allows the user to select the deletion target file depending on the displayed file information. Then, the control unit 170 displays in the display panel 143 whether to back up the selected file or not, and whether to select the encryption setting and the file hiding function or not in case of backing up, and the control unit 170 stores in the storing unit 160 after providing the encryption to the file which is to be backed up, or determining the file hiding function depending on the input of the user. Accordingly, since an access to the backup file is allowed just when a security withdrawing process such as inputting the same encryption as the inputted encryption, or withdrawing the file hiding function is passed through, an illegal use of an unauthorized user can be prevented.

Also, a single encryption may be determined for all over the one or more filed to be backed up, or different encryptions may be determined by each file to be backed up, or by each group.

The image forming apparatus 100 according to the present exemplary embodiment may further include a network connecting unit 120 to connect to an internet as illustrated in FIG. 1.

The network connecting unit 120 may be provided as a network interface card (NIC). Accordingly, the control unit 170 may back up the deletion target file in the host storing unit 310 of the host computer 300 connected to the internet through the network connecting unit 120.

The image forming apparatus 100 according to the present exemplary embodiment may further include the printing unit 150. Here, the printing unit 150 may be provided as an electrophotographic type proceeding charging, exposing, developing, transferring and fusing processes to form an image using a toner, an inkjet type discharging an ink through a nozzle to form an image, a heat transferring type, or other various types.

As described above, the image forming apparatus 100 selects one or more files of the portable storing apparatus 200 to form the deletion target file when there is not enough storing space to store new data in the portable storing apparatus 200. The present general inventive concept is not limited thereto. It is possible that the image forming apparatus 100 selects one or more files from the portable storing apparatus 200 to form the deletion target files when there is not a remaining storing space compared to a reference storing space. In this case, the one or more files can be automatically selected from the portable storing apparatus 200, and the selected one or more files are used to form the deletion target file, when a remaining storing space is smaller than a reference storing space.

When the one or more files are selected from the portable storing apparatus 200, the one or more files can be selected according to a data size from a small data size to a large data size or from a large data size to a small data size.

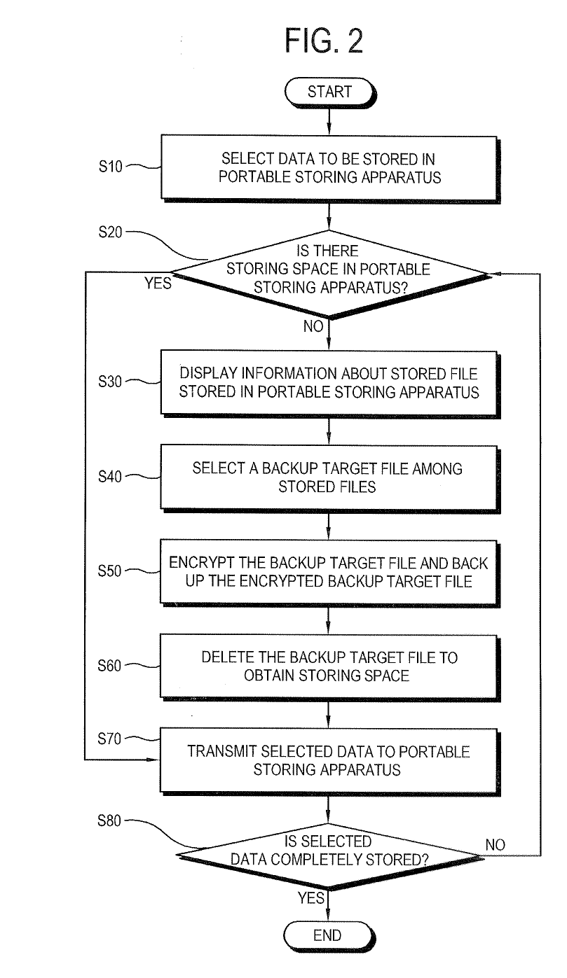

Hereinafter, a data storing method of an image forming apparatus according to exemplary embodiments of the present general inventive concept will be described by referring to FIGS. 2 to 5B.

A data storing method of an image forming apparatus according to an exemplary embodiment is described by referring to FIG. 2. Data to be stored in a portable storing apparatus is selected at operation S10. As described above, a data to be stored in the portable storing apparatus may be selected among a data outputted through a scanning unit 133 of a data output unit 130 of FIG. 1 or an image data receiving unit 135. The selecting of the data to be stored may be manually performed by a user, or automatically performed by a control unit 170 if there is a scanning order from the scanning unit 133, or there is data received from the image data receiving unit 135.

Then, it is determined whether there is a storing space in a portable storing apparatus 200 of FIG. 1 connected to a storing medium connecting unit 100 of FIG. 1 or not at operation S20. Here, the storing space includes a storing space which is insufficient as to store the image data in the portable storing apparatus 200. That is, although the size of the storing space, i.e., a remaining storing space, is smaller than the size of the image data to be stored, it is possible that the storing space is determined to exist except that the storing space is not zero. For example, if the image data is 100 kbyte, and the storing space is 50kbyte, the storing space is determined to exist.

If there is no storing space, information about a stored file stored in the portable storing apparatus 200 is displayed in a display panel 143 in FIG. 1 at operation S30. Also, that there is no storing space in the portable storing apparatus 200 and a file deletion is necessary may be displayed in the display panel 143 of FIG. 1 with the information about the stored file.

A user selects a backup target file which is wanted to be backed up from the displayed information about the stored file at operation S40. Here, the operation S40 may be unnecessary because the control unit 170 may automatically select the backup target file instead of the user. Here, the control unit 170 may select the backup target file depending on a type which is predetermined by means of the user or a manager, or may randomly select the backup target file as necessary.

More in detail, if there is the same duplicate file as an original file in the portable storing apparatus, the control unit 170 of FIG. 1 may back up only the original file. For example, if there are an original file, the name of which is ‘aaa.doc’, and a duplicate file, the name of which is ‘aaa.bak’, the control unit 170 may be determined to back up only the original file, ‘aaa.doc’.

Then, the control unit 170 encrypts the backup target file, and then backs up the backup target file at operation S50. Here, the encryption may be performed by providing a code to the deletion target file, or setting a file hiding function.

Here, the control unit 170 may store the deletion target file in one of a storing unit 160 of an image forming apparatus 100 of FIG. 1 and a host storing unit 310 of a host computer 300 to perform the backup.

Also, the control unit 170 deletes the deletion target file from the portable storing apparatus to obtain a storing space at operation S60.

Then, the control unit 170 transmits the data selected in the operation S10 to the portable storing apparatus at operation S70.

It is determined whether the transmitted data is completely stored in the portable storing apparatus or not at operation S80, and the method is ended if the storing is completed.

In the operation S80, if the storing is not completed, it returns to the operation S20 in which it is determined whether there is the storing space in the portable storing apparatus or not. More in detail, the storing is completed if the size of the storing space obtained in the operation S60 is bigger than that of the data which is to be stored. However, since the storing is not completed if the size thereof is not bigger than that of the data, the operations S20 to S60 are repeated to obtain the storing space in the portable storing apparatus. Accordingly, although there is no storing space while the selected data is stored in the portable storing apparatus, the storing space can be obtained so that the data can be successively stored in the storing space. Accordingly, the data can be completely stored in the portable storing apparatus.

When there is no storing space at operation S20, the data to be stored is transmitted to the portable storing apparatus at operation S70.

Here, a part or all of the above operations S30 and S40 may be omitted as necessary. If all the operations S30 and S40 are omitted, the control unit 170 may select the deletion target file randomly or with a predetermined type to forcedly delete without asking an intention of the user. Here, as described above, the predetermined type may be a type determining whether there are an original and a duplicate having the same names or not to delete only the duplicate in advance. Alternatively, the predetermined type may employ other various types.

Also, the predetermined type may be previously determined by means of the user. For example, if the user may previously determine a specific extension name (‘hwp’, ‘bak’, ‘doc’, etc.), or a specific file name for the deletion target file, the control unit 170 may confirm correspondence to select the deletion target file.

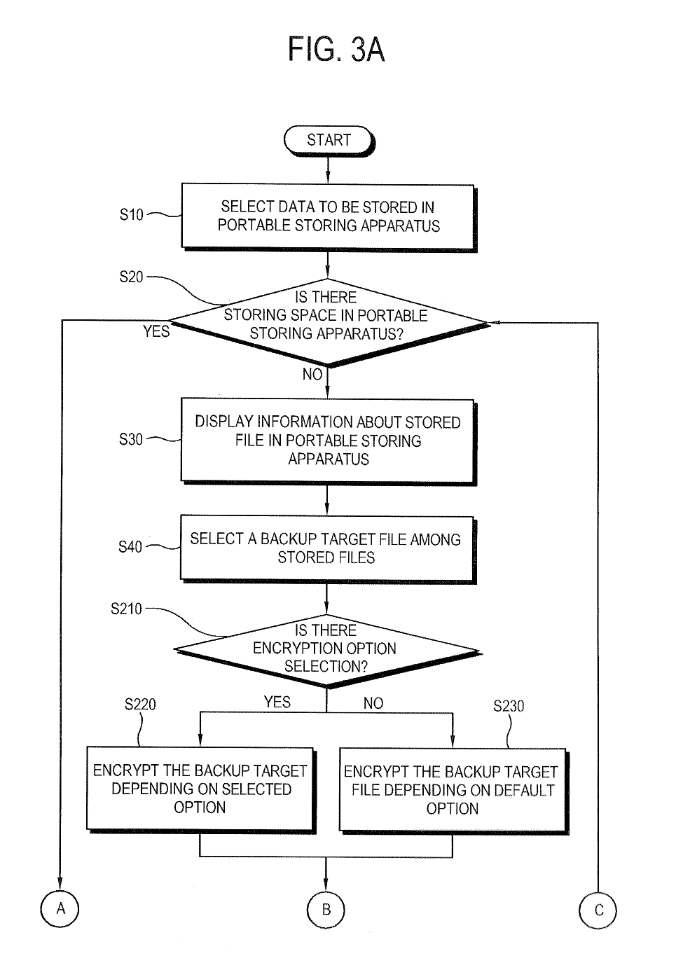

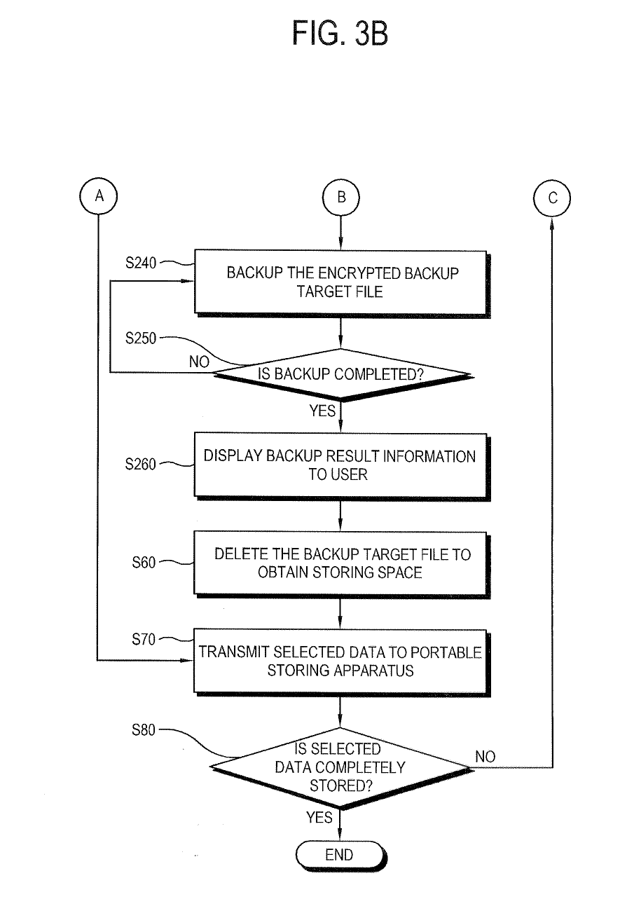

Hereinafter, a data storing method of an image forming apparatus according to an exemplary embodiment of the present general inventive concept will be described by referring to FIGS. 3A and 3B.

As illustrated in FIGS. 3A and 3B, the data storing method according to the present embodiment is similar to the data storing method of FIG. 2. Operations having the same reference numerals may have the same functions, and description thereabout may be omitted.

Compared with the embodiment of FIG. 2, the embodiment of FIGS. 3A and 3B distinctly has operations S210 to S260 which replace the operation S50 of the embodiment of FIG. 2. More in detail, it is determined whether there is selection of an encryption option (at least one of an encryption setting and a file hiding function) for a selected backup target file by means of a user or not at operation S210.

If there is the selection, the backup target file is encrypted depending on the selected option at operation S220. If there is no selection, the backup target file is encrypted depending on a default option at operation S230.

Then, the encrypted file is backed up at operation S240. If the backup is completed at operation S250, backup result information is displayed to the user at operation S260.

Here, the backup result information includes information about the setting of the encryption and file hiding function which the user determines, and may further include at least one of a name information about the back up file and a backup date. Also, the backup result information may include an internet protocol (IP) address, a media access control (MAC) address or the name of a host apparatus which backs up the backup target file, and the name of the backup target file. The back up result information may be stored in the portable storing apparatus 200, the image forming apparatus 100, and/or an external apparatus, such as the host computer 300.

Alternatively, the encryption type may employ other types besides the encryption setting and the file hiding function as long as it can prevent an unauthorized user from illegally using.

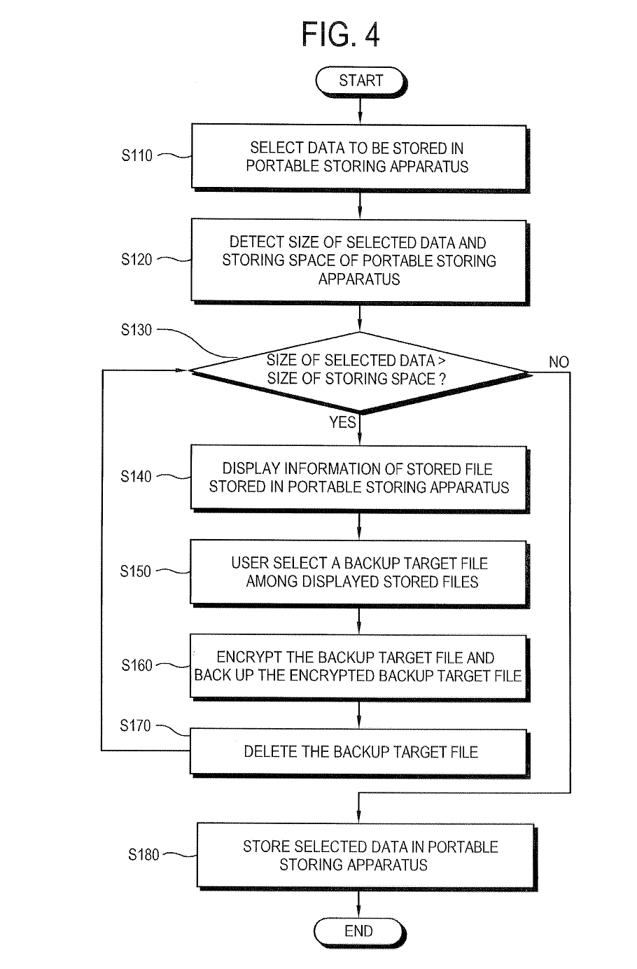

Hereinafter, a data storing method of an image forming apparatus according to an exemplary embodiment of the present general inventive concept will be described by referring to FIG. 4.

At first, data which is to be stored in a portable storing apparatus is selected at operation S110.

Then, the size of the selected data, and the size of a storing space of a portable storing apparatus 200 of FIG. 1 are detected at operation S120.

It is determined whether the size of the image data is bigger than the size of the storing space or not at operation S130, and the selected data is transmitted to the portable storing apparatus to be stored therein if the former is the same as the latter, or is smaller than the latter at operation S170.

If the former is bigger than the latter, information about a stored file stored in the portable storing apparatus is displayed in a display panel 143 of FIG. 1 at operation S140, and the user selects a deletion target file among the displayed stored file at operation S150. The information about the stored file may include at least one of the name, size and a making data of the stored file.

As necessary, if there is no input from the user although the information about the stored file is displayed in the display panel 143 for a predetermined period of time, a part or all of the stored files may be selected as the backup target file. This forced backup target file selection may be applied to the other exemplary embodiments.

Then, the backup target file is encrypted and backed up at operation S160. Then, the backup target file is deleted from the portable storing apparatus 200 of FIG. 1 to provide the storing space at operation S170, and the operations S130 to S170 are repeated until the size of the storing space is the same as or bigger than the size of the image data, that is, the storing space capable of storing the image data is generated in the portable storing apparatus 200.

If the storing space capable of storing the image data is generated at operation S130, the image data is transmitted to the portable storing apparatus 200, and stored therein at operation S180.

Compared with the exemplary embodiments of FIGS.2, 3A, and 3B in which the selected data is transmitted to the portable storing apparatus 200 although a small storing space is obtained, the embodiment of FIG. 4 has the distinction that the selected data is transmitted to the portable storing apparatus 200 after the storing space is sufficiently obtained in the portable storing apparatus 200 as to store the image data.

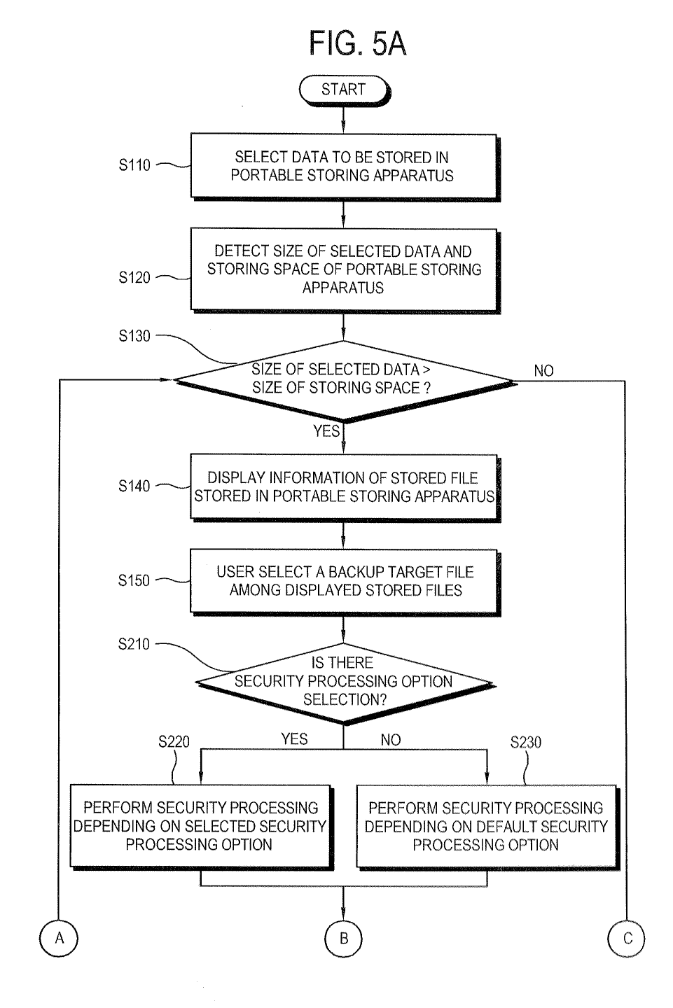

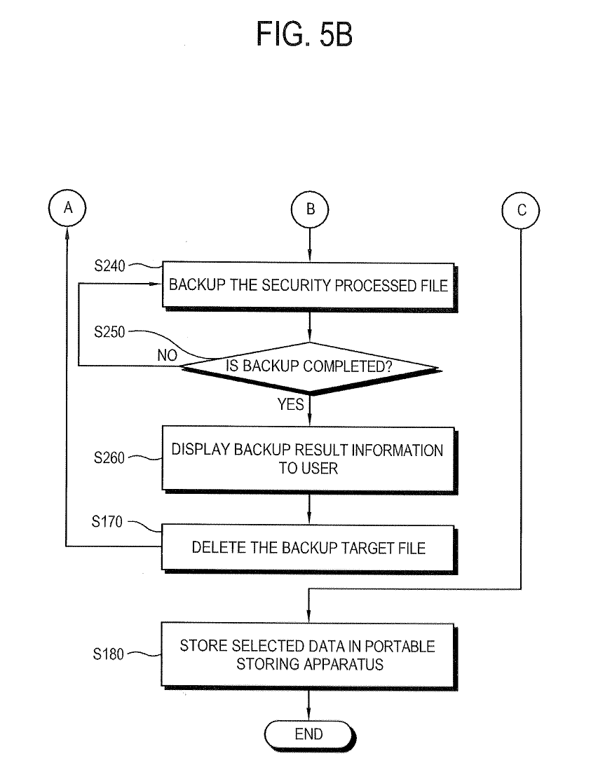

As illustrated in FIGS. 5A and 5B, a data storing method of an image forming apparatus according to an exemplary embodiment of the present general inventive concept is similar to the embodiment of FIG. 4.

The difference therebetween is that the operation S160 of the exemplary embodiment of FIG. 4 is replaced by operations S210 to S260 of the exemplary embodiment of FIGS. 5A and 5B.

The operations S210 to S260 may have the same configurations as the embodiment of FIGS. 3A and 3B. Accordingly, a backup file can be prevented from being used by an unauthorized user.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As describe above, an image forming apparatus, a data storing method thereof and a computer readable recording medium having a program executing the data storing method according to the present general inventive concept have the following effects.

First, if there is no available storing space in a portable storing apparatus, it is necessary to delete a part or all of one or more stored files stored therein to obtain a storing space. Information about the stored file is displayed to a user of the portable storing apparatus, thereby improving a user convenience.

Second, a file which is a deletion target among the stored files is backed up in security, thereby preventing an unauthorized user from illegally using the backup file.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A data storing method of an image forming apparatus which is capable of being connected to a portable storing apparatus, the data storing method comprising:
selecting data to be stored in the portable storing apparatus;
selecting a backup target file among one or more stored files in the portable storing apparatus, and encrypting the backup target file if a storing space of the portable storing apparatus in which the selected data is to be stored is insufficient;
deleting the backup target file, and backing up the encrypted backup target file; and
storing the selected data in the portable storing apparatus.

2. The data storing method of claim 1, further comprising:
displaying the stored file to select the backup target file.

3. The data storing method of claim 1, wherein the encrypting comprises determining at least one of an encrypting function and a file hiding function to the backup target file.

4. The data storing method of claim 3, wherein the backing up comprises storing the backup target file in a storing unit of the image forming apparatus or a storing unit of a host apparatus.

5. The data storing method of claim 4, wherein the backing up comprises allowing a user to select at least one of the encrypting function and the file hiding function.

6. The data storing method of claim 1, further comprising:
displaying a backup result of the backup target file.

7. An image forming apparatus which is capable of being connected with a portable storing apparatus, the image forming apparatus comprising:
a data output unit which outputs an image data; and
a control unit which encrypts a backup target file among a stored file which is stored in the portable storing apparatus and backs up the encrypted backup target file and deletes the backup target file in the portable storing apparatus, and then stores the image data in the portable storing apparatus if there is no storing space in the portable storing apparatus.

8. The image forming apparatus of claim 7, wherein the control unit determines at least one of an encrypting function and a file hiding function to the backup target file.

9. The image forming apparatus of claim 8, further comprising:
a display panel,
wherein the control unit displays in the display panel so that a user can select at least one of the encrypting function and the file hiding function.

10. The image forming apparatus of claim 7, further comprising:
a display panel,
wherein the control unit displays the stored file in the display panel so that a user can select the backup target file.

11. The image forming apparatus of claim 7, further comprising:
a display panel,
wherein the control unit displays a backup result of the encrypted backup target file in the display panel.

12. A computer readable recording medium to contain computer-readable codes as a computer program which is provided to an image forming apparatus to execute a data storing method of the image forming apparatus, the data storing method comprising:
selecting data to be stored in the portable storing apparatus;
selecting a backup target file among one or more stored files in the portable storing apparatus, and encrypting the backup target file if a storing space of the portable storing apparatus in which the selected data is to be stored is insufficient;
deleting the backup target file, and backing up the encrypted backup target file; and
storing the selected data in the portable storing apparatus.

13. An image forming apparatus connectable with a portable storing apparatus, the image forming apparatus comprising:
a connecting port connectable to an external portable storing apparatus; and
a control unit to communicate with the external portable storing apparatus through the connecting port, to delete at least one of one or more files stored in the external portable apparatus and to increase from a first storing space to a second storing space of the external portable apparatus according to the deletion of the at least one file,
wherein the control unit creates an encryption file to correspond to the at least one of the files to be deleted, and stores the encryption file and information on the encryption file in at least one of a storage unit and the external portable storing apparatus.

14. The image forming apparatus of claim 13, wherein the control unit selects the at least one of the files to be deleted when the control unit determines that the first storing space is smaller than a reference storing space.

15. The image forming apparatus of claim 13, wherein the files have priority, and the control unit selects the at least one of the files to be deleted according the priority of the files.

16. The image forming apparatus of claim 13, wherein the control unit stores data in the external portable storing apparatus when there is an available storing space to store the data according to the deletion of the at least one file.
